(19) United States
(12) Patent Application Publication
(10) Pub. No.: US 2019/0141942 A1
(43) Pub. Date: May 16, 2019

(54) MILKING SYSTEM AND METHOD

(71) Applicant: Bullseye Australia Pty Ltd., Beaconsfield (AU)

(72) Inventor: Richard Paul Wallace, Beaconsfield (AU)

(73) Assignee: Bullseye Australia Pty Ltd., Beaconsfield (AU)

(21) Appl. No.: 16/098,743

(22) PCT Filed: May 4, 2017
(86) PCT No.: PCT/AU2017/050412

§ 371 Date: Nov. 2, 2018

(30) Foreign Application Priority Data
May 4, 2016 (AU) 2016901646
Aug. 19, 2016 (AU) 2016216736
Dec. 7, 2016 (AU) 2016905047

(51) Int. Cl. A01J 5/007; A01J 5/16; A01J 5/01

(52) U.S. Cl. CPC A01J 5/0075; A01J 5/01; A01J 5/16

(57) ABSTRACT

The present disclosure provides a method of milking a mammal which includes, applying a vacuum to the lower end of a milking cup liner; and modulating the pressure in the pulsation volume to cause a milking operation on a teat of an animal that is inserted into the top end of the bore. The modulation includes an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat. The modulation includes applying positive pressure to the pulsation volume to apply compressive load to the teat.

### FIELD OF THE INVENTION

The present invention relates to milking systems and methods, e.g. of the type used to milk mammals. For convenience only, illustrative embodiments of the present invention will be described with reference to milking cows, but the present systems and method should not be considered as being limited to this use.

### BACKGROUND OF THE INVENTION

U.S. Pat. No. 5,178,095, (the contents of which are incorporated herein by reference) describes a system for milking mammals which applies a positive pressure between a shell wall of a teat-cup and its flexible liner to during the “off” phase of the pulsation cycle in order to isolate the teat tip from the negative pressure applied to the milk delivery tube of the teat cup. During the “on” phase of the pulsation cycle negative pressure is applied between the liner and teat-cup shell to partially open a flow path through the liner along which milk can flow via negative pressure applied to the milk tube.

However this proposal only partly addresses the issues of minimising damage to the teat of the animal through the application of vacuum to the tip of the teat during the milking process. The present invention seeks to provide improved milking systems and methods that ameliorate some of the drawbacks of such a system or at least provide a useful alternative for the public.

### SUMMARY OF THE INVENTION

The present inventor has determined that the milk flow in the liner bore during the “on” cycle reduces vacuum level in the milking tube to a sufficient extent that the pressure differential across the liner wall can be affected sufficiently to compromise the closing the liner bore in the off phase of the milking operation. Moreover the inventor has realised that teat damaged may be reduced by providing a controlled compressive load on the teat between milking “on” periods. Most preferably the compressive load should be sufficient to drive blood and lymphatic fluid upwards and out of the teat. The compressive load should be above 2.0 N/cm². In some embodiments preferably it is at or about 2.5 N/cm². In other embodiments additional compressive load may be advantageous, for example in the range of 2.5 N/cm² to 3.5 N/cm².

In one aspect the present invention provides a method of milking a mammal using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:

Applying a vacuum to the lower end of the liner wherein vacuum is applied at level of less than 42 kPa;

Modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat.

The vacuum applied can be less than 38 kPa. Preferably it is less than 37 kPa. Most preferably it is less than 36 kPa. A preferred form uses a 35 kPa system vacuum.

Preferably the method can include applying compressive load to the teat in a manner that causes application of said load at the lowermost part of the teat before the application of compressive load higher up the teat. Preferably the compressive load is initially applied to the lowermost 1 to 3 mm of the teat. Most preferably the compressive load is initially applied to the lowermost 2 mm.

The method can include providing collapsing means to cause sequential collapse of the liner against the teat from the lowermost part of the teat. The collapsing means can include an insert placed within the pulsation volume. In other embodiments the collapsing means can include a profiled inner surface of the shell. The insert or profiled inner surface of the shell can include an inwards projection configured to indent the liner to pinch the liner bore at a location below the tip of the teat.

According to a further aspect the present invention provides a method of milking a mammal using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat , the method including:

Applying a vacuum to the lower end of the liner;

Modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat and to apply compressive load to the teat; the method further including:

Determining a pressure in the bore; and

Applying a positive pressure to the pulsation volume in the off phase, wherein the level of positive pressure applied is determined on the basis of said determined pressure.

The pressure can be determined by any one or more of the following:

Measuring pressure at or near the lower end of the bore or other related position;

Estimating pressure at or near the lower end of the bore my measuring a milk flow rate or milk flow volume, from the bore.

The pressure is determined at least at a time when milk is flowing during the “on” phase. Most preferably it is determined at a plurality of points during the pulsation cycle across both the off and on phases. In some embodiments pressure is determined continuously while the animal is being milked.

The compressive load applied to the teat by the liner that is caused by the application of increased pressure in the pulsation volume is preferably above 2.0 N/cm². in some embodiments it is at or about 2.5 N/cm². In other embodiments additional compressive load may be advantageous, for example in the range of 2.5 N/cm² to 3.5 N/cm².

The method can include connecting the pulsation volume to a source of air to apply the positive pressure. The source can apply a predefined volume of air to the pulsation volume that corresponds to the determined level of positive pressure to be applied.

Preferably the method can include applying compressive load to the teat in a manner that causes application of said load at the lowermost part of the teat before the application of compressive load higher up the teat. Preferably the compressive load is initially applied to the lowermost 1 to 3 mm of the teat. Most preferably the compressive load is initially applied to the lowermost 2 mm.

The method can include providing collapsing means to cause sequential collapse of the liner against the teat from the lowermost part of the teat.

The milking cup can include an insert placed within the pulsation volume. The insert may cause one or more of the following:
control or limit movement of the liner;
reduce the volume of the pulsation volume (compared to the volume that would exist absent the insert).

Controlling or limiting the movement of the liner can include acting as the, or part of the collapsing means. The collapsing means can additionally or alternatively include a profiled inner surface of the shell. The insert or profiled inner surface of the shell can include an inwards projection configured to indent the liner to pinch the liner bore at a location below the tip of the teat to thereby induce initial liner collapse at said location.

In a second aspect the present invention provides a method of milking a mammal using a milking cluster including a plurality of milking cups of the type including a shell and a flexible liner, said liner including a hollow bore for receiving an animal's teat at a top end thereof, and being connected (usually indirectly) to a milk tube at the lower end thereof, said milk tube being adapted to apply a vacuum to the bore of the liner and convey milk to a milk reservoir; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; the method including:

for each milking cup, applying a vacuum to its liner bore;

modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat and to apply compressive load to the teat; the method further including:

determining a pressure in the bore; and

applying a positive pressure to the pulsation volume in the off phase, wherein the level of positive pressure applied is determined on the basis of said determined pressure.

In a third aspect the present invention provides a method of milking a mammal using a milking machine including a plurality of milking cups of the type including a shell and a flexible liner, said liner including a hollow bore for receiving an animal's teat at a top end thereof, and being connected (possibly indirectly) to a milk tube at the lower end thereof, said milk tube being adapted to apply a vacuum to the bore of the liner and convey milk to a milk reservoir; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; the method including:

for each milking cup, applying a vacuum to its liner bore;

modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat and to apply compressive load to the teat; the method further including:

determining a pressure in the bore; and

applying a positive pressure to the pulsation volume in the off phase, wherein the level of positive pressure applied is determined on the basis of said determined pressure.

The milking machine can be an automated milking system, such as a robotic milking system.

In embodiments of the second and third aspects of the invention, the pressure can be determined by any one or more of the following:

Measuring pressure at or near the lower end of the liner bore or other related position, such as in the milk tube, milk reservoir or a manifold to which one or more of the liner bores are connected;

Estimating pressure at or near the lower end of the liner bore by measuring a milk flow rate or milk flow volume. The milk flow rate or volume can be measured in the liner bore, in the milk tube, in a milk reservoir, or a manifold to which the liner bores are connected, or any downstream point.

The pressure is determined at least at a time when milk is flowing during the “on” phase. Most preferably it is determined at a plurality of points during the pulsation cycle across both the off and on phases. In some embodiments pressure is determined continuously while the animal is being milked.

In embodiments of the second and third aspects of the invention the compressive load applied to the teat by the liner that is caused by the application of increased pressure in the pulsation volume is preferably above 2.0 N/cm². In some embodiments it is at or about 2.5 N/cm². In other embodiments additional compressive load may be advantageous, for example in the range of 2.5 N/cm² to 3.5 N/cm².

The methods can include connecting the pulsation volume to a source of air to apply the positive pressure. The source can apply a predefined volume of air to the pulsation volume that corresponds to the determined level of positive pressure to be applied.

Preferably the methods can include applying compressive load to the teat in a manner that causes application of said load at the lowermost part of the teat before the application of compressive load higher up the teat. Preferably the compressive load is initially applied to the lowermost 1 to 3mm of the teat. Most preferably the compressive load is initially applied to the lowermost 2 mm.

The methods can include providing collapsing means to cause sequential collapse of the liner against the teat from the lowermost part of the teat.

The milking cup, in embodiments of the second and third aspects of the invention, can include an insert placed within the pulsation volume. The insert may cause one or more of the following:
control or limit movement of the liner;
reduce the volume of the pulsation volume (compared to the volume that would exist absent the insert).

Controlling or limiting the movement of the liner can include acting as the, or part of the collapsing means. The collapsing means can additionally or alternatively include a profiled inner surface of the shell. The insert or profiled inner surface of the shell can include an inwards projection configured to indent the liner to pinch the liner bore at a location below the tip of the teat to thereby induce initial liner collapse at said location.

In a further aspect the present invention provides a pressure compensation system for use with a milking system which includes:
at least one milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,
a vacuum system in fluid communication the bore of the liner and the pulsation volume;
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat and to apply compressive load to the teat;
a milk reservoir in fluid communication with the liner bore and adapted to receive milk;

the pressure compensation system including:

a sensing system configured to measure a fluid parameter related to a pressure in the bore;

a source of positive air pressure air in fluid communication with the pulsation volume; and

a controller configured to control the pressure compensation system to adjust a level of positive pressure applied to the pulsation volume based on said determined fluid parameter measurement.

The sensing system can include any one or more of the following:

A transducer to measure pressure located at or near the lower end of the bore or other related position;

a sensor to determine milk flow rate or milk flow volume, from the bore.

The sensing system can determined pressure at least at a time when milk is flowing during the “on” phase. Most preferably it is determined at a plurality of points during the pulsation cycle across both the off and on phases. In some embodiments pressure is determined continuously while the animal is being milked.

The pressure compensation system can be configured to supply a predefined volume of air to the pulsation volume that corresponds to the determined level of positive pressure to be applied.

The pressure compensation system can include one or more fluid delivery lines connected between the source of positive air pressure and the pulsation volume.

The pressure compensation system can further include one or more valves or actuators to control fluid flow in the pressure regulating system.

The compressive load is preferably applied the teat in a manner that causes application of said load at the lowermost part of the teat before the application of compressive load higher up the teat. Preferably the compressive load is initially applied to the lowermost 1 to 3 mm of the teat. Most preferably the compressive load is initially applied to the lowermost 2 mm.

The pressure compensation system can include collapsing means to cause sequential collapse of the liner against the teat from the lowermost part of the teat.

The pressure compensation system can include an insert placed within the pulsation volume. The insert may cause one or more of the following:
control or limit movement of the liner;
reduce the volume of the pulsation volume (compared to the volume that would exist absent the insert).

Controlling or limiting the movement of the liner can include acting as the, or part of the collapsing means. The collapsing means can additionally or alternatively include a profiled inner surface of the shell. The insert or profiled inner surface of the shell can include an inwards projection configured to indent the liner to pinch the liner bore at a location below the tip of the teat to thereby induce initial liner collapse at said location.

The pressure compensation system can further include a wireless communications system configured to enable communication between at least the sensing system and controller. The wireless communications system may also be configured to enable communication between the controller and the one or more valves or actuators.

The pressure compensation system can be configured to cause a compressive load to be applied to the teat by the liner, that is preferably above 2.0 N/cm². In some embodiments it is at or about 2.5 N/cm². In other embodiments additional compressive load may be advantageous, for example in the range of 2.5 N/cm² to 3.5 N/cm².

In a further aspect the present invention provides a milking system including

at least one milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,

a vacuum system in fluid communication the bore of the liner and the pulsation volume;

a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to cause the liner bore to close to thereby stop milk flow from the teat and apply a compressive load to the teat;

at least one milk receiving sub-system, in fluid communication with the liner bore and adapted to receive milk; and

a pressure compensation system including:
a sensing system configured to measure a fluid parameter related to a pressure in the bore;
a source of positive air pressure air in fluid communication with the pulsation volume; and
a controller configured to control the pressure compensation system to adjust a level of positive pressure applied to the pulsation volume based on said determined fluid parameter measurement.

Preferably the application of positive increased pressure in the pulsation volume causes the application of a compressive load applied to the teat by the liner of more than above 2.0 N/cm². In some embodiments it is at or about 2.5 N/cm². In other embodiments additional compressive load may be advantageous, for example in the range of 2.5 N/cm² to 3.5 N/cm².

The compressive load is preferably applied the teat in a manner that causes application of said load at the lowermost part of the teat before the application of compressive load higher up the teat. Preferably the compressive load is initially applied to the lowermost 1 to 3 mm of the teat. Most preferably the compressive load is initially applied to the lowermost 2 mm.

The pressure compensation system can include collapsing means to cause sequential collapse of the liner against the teat from the lowermost part of the teat.

The pressure compensation system can include an insert placed within the pulsation volume. The insert may cause one or more of the following:
control or limit movement of the liner;
reduce the volume of the pulsation volume (compared to the volume that would exist absent the insert).

Controlling or limiting the movement of the liner can include acting as the, or part of the collapsing means. The collapsing means can additionally or alternatively include a profiled inner surface of the shell. The insert or profiled inner surface of the shell can include an inwards projection configured to indent the liner to pinch the liner bore at a location below the tip of the teat to thereby induce initial liner collapse at said location.

The sensing system can include any one or more of the following:
a transducer to measure pressure located at or near the lower end of the bore or other related position;
a sensor to determine milk flow rate or milk flow volume, from the bore.

The pressure is determined at least at a time when milk is flowing during the “on” phase. Most preferably it is determined at a plurality of points during the pulsation cycle across both the off and on phases. In some embodiments pressure is determined continuously while the animal is being milked.

The pressure compensation system can be configured to supply a predefined volume of air to the pulsation volume that corresponds to the determined level of positive pressure to be applied.

The pressure compensation system can include one or more fluid delivery lines connected between the source of positive air pressure and the pulsation volume.

The pressure compensation system can further include one or more valves or actuators to control fluid flow in the pressure regulating system.

The pressure compensation system can further include a wireless communications system configured to enable communication between at least the sensing system and controller. The wireless communications system may also be configured to enable communication between the controller and the one or more valves or actuators.

In one form the pressure compensation system forms part of the pressure regulating system.

In the above aspects of the present invention the source of positive air pressure can be connected, for example, directly or indirectly to any one of the following locations:

An inlet to a pulsator;

A pulsation volume;

At a position adjacent to or along the length of either a long pulsation tube or a short pulsation tube;

A volume or manifold in fluid communication with any one of the above.

In another aspect the present invention provides a milking system configured to perform a method as described herein.

In each of the aspects disclosed herein the compressive load can be greater than about a blood pressure in the animal's teat, say above a pressure of 0.8 to 1.2 Ncm⁻². In some embodiments the compressive load at or above 1.2 Ncm⁻². In some embodiments the compressive load is above 1.5 Ncm⁻². In some embodiments the compressive load is above 2.0 Ncm⁻². In some embodiments the compressive load is above between about 2.0 and 2.5 Ncm⁻². In some case a higher compressive load may be desirable, for example in the range of 2.5 N/cm² to 3.5 N/cm² or more.

It is possible that in each of the aspects set out above, that the vacuum level applied will be less than 42 kPa. It can be less than 40 kPa or 38 kPa. Preferably it is less than 37 kPa. Most preferably it is less than 36 kPa. A preferred form uses about 35 kPa.

The present inventor has also determined in systems such as those described above that the milking system can be simplified by the use of a new valve arrangement. The valve arrangement of the preferred embodiments of the present disclosure can be used to replace the pulsator in a conventional milking system as will be set out below, and can also be used to deliver air at a positive pressure (i.e. above atmospheric pressure) to implement methods in accordance with aspects of the present disclosure.

In a first aspect there is provided an air pressure valve arrangement for a milking system, said valve having:

a positive air pressure inlet port for coupling to a source of air at a first pressure above atmospheric pressure;

a first vacuum port for coupling to a vacuum source being a source of air at a pressure lower than atmospheric pressure;

a positive air pressure outlet port for outputting air at a second positive pressure above atmospheric pressure;

a first flowpath between the positive air pressure inlet port and the positive air pressure outlet port;

a vacuum flowpath extending from the first vacuum port to a second vacuum port

a positive air pressure valve movable between an open and closed position and located in the first flowpath to control the movement of air with positive air pressure between the positive air pressure inlet port and the positive air pressure outlet port;

a vacuum valve movable between an open and closed position and located in the vacuum flowpath to control the coupling of vacuum between the first vacuum port and the second vacuum port;

wherein the positive air pressure valve and vacuum valve are acuatable in concert with each other so that the air pressure valve arrangement can take the following states:
a first vacuum position in which the vacuum flowpath is open;
a first pressurised position in which the first flowpath is open;
a blocked position in which both the vacuum flowpath and first flowpath are closed.

The valve arrangement can include: a first coupling to receive an airline delivering air at a positive air pressure for delivery to the inlet port; a second coupling to receive an airline for connecting to the vacuum source for delivering air at a pressure below atmospheric pressure to the vacuum port.

The valve arrangement can further include a coupling manifold located between the positive air pressure outlet port and the second vacuum port, and a final outlet port, to enable the selective coupling of either vacuum or air at a positive air pressure between the first vacuum port and positive air pressure inlet port respectively, and the final outlet port. In such embodiments the valve arrangement can include a third coupling in fluid communication with the final outlet port to receive an airline in fluid communication with a pulsation volume of at least one teat cup of the milking system.

In alternative embodiments, which omit the coupling manifold, the valve arrangement can include and a fourth and fifth coupling in fluid communication with the positive air pressure outlet port and the second vacuum port respectively, to each receive a respective airline to enable fluid communication with a pulsation volume of at least one teat cup of the milking system.

The valve arrangement can include one more actuators for actuating one or both of the positive air pressure valve and the vacuum valve. The positive air pressure valve and the vacuum valve can be mechanically coupled to each other to move in concert.

In some embodiments, the valve arrangement includes a common valve body which houses both the positive air pressure valve and the vacuum valve. In such embodiments the valve body can include a valve body manifold connecting the positive air pressure inlet port to the positive air pressure outlet port, and the first vacuum port to the second vacuum port.

In some embodiments the valve arrangement includes a vent valve arrangement.

Each valve will include a closure member moveable to open or close the respective valve. Said closure members can be independently actuated in some embodiments by respective actuators. In preferred embodiments the closure members are mechanically coupled to each other. In a particularly preferred form they form parts of a common member, such as: a spool or poppet, or other linearly movable closure member; a plug or ball, or other rotatably moveable closure member.

In a further aspect there is disclosed a valve system for a milking system comprising a plurality of air pressure valve arrangements as set out above. The valve system can include two air pressure valve arrangements as disclosed above. The air pressure valve arrangements can be actuated in a predetermined sequence relative to each other.

A valve arrangement and/or valve system of the above mentioned aspect of the invention may form part of a pressure regulation system and pressure compensation system of a milking system according to an embodiment of any of the aspects set out above. This is particularly the case in forms of the above mentioned systems where the pressure compensation system forms part of the pressure regulating system.

It should be noted that the concept of applied vacuum level, relates not to the actual instantaneous vacuum level measured at a point within the system, but an intended vacuum level, also termed “system vacuum” herein. The actual instantaneous vacuum level measured at a point within the system will differ from this level because of factors such as milk flow within a limited space and the available “air space” between the milk line and the cluster. This vacuum level is also called the “operating vacuum” herein. In particular the concept of applying a vacuum to the lower end of the liner at a given pressure level should be understood to mean the system vacuum level applied by a vacuum system, e.g. to the long milk tube, and not the resultant (and highly variable) instantaneous teat-end vacuum (operating vacuum) experienced by the animal.

Embodiments of the various aspects of the present invention, preferably using the parameters described herein, can advantageously be applied to the milking of cows.

### BRIEF DESCRIPTION OF THE DRAWINGS

Embodiments of the present invention will be described by way of non-limiting example only with reference to the accompanying drawings. In the drawings:

FIG. 1a is a schematic illustration of a milking system according to an embodiment of the present invention;

FIG. 1b illustrates a conventional milking cup, which may be used in some embodiments;

FIG. 1c illustrates a milking cup of a robotic milking system;

FIG. 2 is a plot of the pressure level (vacuum) applied in the pulsation volume of a milk cup during a conventional pulsation cycle;

FIG. 3 illustrates a milking cup with a teat inserted therein during an “off” phase of the pulsation cycle;

FIG. 4 illustrates a timing diagram for the application of positive air pressure to the pulsation volume of a milking cup during the pulsation cycle;

FIGS. 5a and 5b illustrate time plots of the modified pressure in pulsation volume in an embodiment of the present invention;

FIG. 6 illustrates a plot of the compressive load vs vacuum in the liner bore in a milking system; and

FIG. 7 illustrates a plot similar to that of FIG. 5b showing the modified pressure in pulsation volume in an embodiment of the present invention having 2×2 pulsation;

FIG. 8 illustrates a schematic cross section of a milking cup, including an insert, that can be used in embodiments of the present invention;

FIG. 9 illustrates another embodiment of a milking system according to the present invention;

FIG. 10 illustrates a plot of absolute pressure in the liner bore and the level of positive air pressure that may be added in an embodiment of the present invention.

FIG. 11 is a plot of the measured vacuum in a milk tube for a milking cow over a single milking cycle.

FIG. 12 is a diagram illustrating the benefits which may be gained by use of preferred embodiments of the present invention in cow milking.

FIG. 13 is a schematic representation of components of a milking system including a pressure compensation system having a valve arrangement according to an embodiment of an aspect of the present invention.

FIGS. 14a to 14c illustrate a valve arrangement according to an embodiment of the present invention in three different configurations.

FIG. 15 illustrates a second valve arrangement according to an embodiment of the present invention.

FIG. 16 is a schematic illustration of a further example of a valve arrangement according to an embodiment of the present invention.

### DETAILED DESCRIPTION OF THE EMBODIMENTS

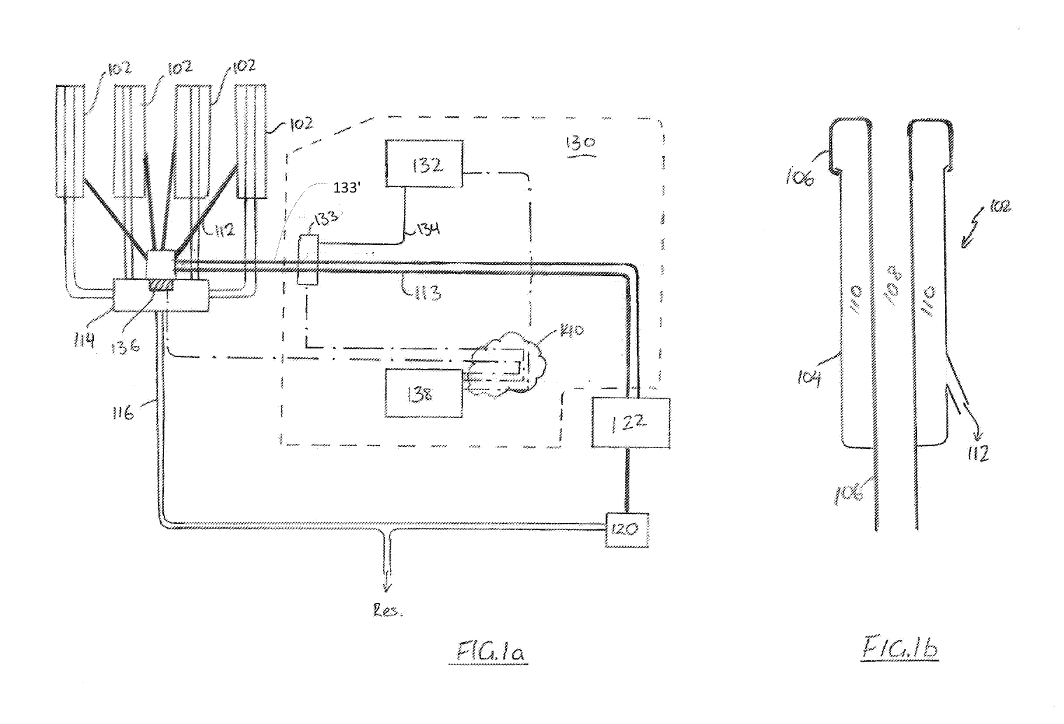

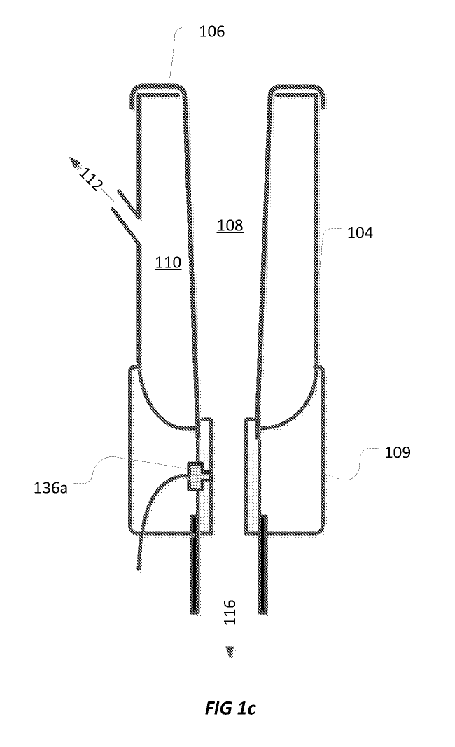

FIGS. 1a and 1b are a schematic illustration of a milking system 100 according to an embodiment of an aspect of the present invention. The milking system 100 can be considered to be a conventional milking system, including a conventional automatic milking system (such as a robotic milking machine) that has been modified to include a pressure compensation system according to an embodiment of an aspect of the present invention so that it can implement a method according to an embodiment of a further aspect of the present invention.

The milking system includes at least one (in this example 4) milking cup 102, details of which are shown in FIG. 1B. The milking cup 102 generally includes a shell 104 and a flexible liner 106. The liner 106 is generally tubular (but may have a non-round cross section, e.g. triangular) and includes a hollow bore 108. In use the bore receives the animal's teat at its top end for milking. The lower end of the bore 108 is connected to the milking claw 114, which in turn connects to a milk tube 116. The milk tube 116 connects the liner bore 108 to a vacuum system 120 in a manner that will be known to those skilled in the art. The liner 106 and shell 104 are sealed to each other in relative positions so as to create a pulsation volume 110 between them in. As is known in the art, in order to milk the animal the fluid pressure (vacuum) in the pulsation volume 110 is modulated control a pressure differential across the liner between its bore and the pulsation volume. Conventionally the vacuum in the pulsation volume is used to open the bore 108 of the liner 106 to enable milk to flow within the bore 108 towards the milk tube 116. Typically the milking claw 114 will have a manifold within it that connects several liners 106 to the milk tube 116.

In the case that the milking system is an automatic milking system such as a robotic milking machine the milking cup 102 will be generally similar to the embodiment of FIG. 1b, but may not be part of a claw 114 as described above. Such an example is illustrated in FIG. 1c and will be described below.

The vacuum system 120 generally comprises a vacuum pump that is connected to, the bore of the liner 106 (possibly via intervening connections), and the pulsation volume 110 via a pressure regulating system 122.

The pressure regulating system 122, which may conventionally be a pulsator, is configured to modulate the fluid pressure in the pulsation volume 110 of the milking cup(s) 102, to cause a milking operation on the teat. The pulsator 122 is fluidly connected to the pulsation volume 110 of one or more teat cups by one or more long pulsation tube(s) 113 and respective short pulsation tubes 112. In this example the system has a 2×2 milking cluster and hence 2 long pulsation tubes are used. In other embodiments a different number of long pulsation tubes may be used. As will be known the pulsation cycle of the milking operation generally includes an “on” phase in which the vacuum that is applied to the liner bore is less than a vacuum applied to the pulsation volume. The pressure differential across the liner 106 causes its bore 108 to be opened so that the teat is exposed to the vacuum in the bore 108 to thereby enable milk flow from the teat. In an “off” phase the pressure in the pulsation volume 110 is increased relative to the “on” phase. Conventionally, the pulsation volume 110 is opened to atmosphere by the pressure regulation system 122. The pressure differential across the liner 106 causes the liner bore 108 to close.

The present embodiment additionally includes a pressure compensation system 130. The pressure compensation system 130 primarily includes a source 132 of positive air pressure. The source could be a pump, compressor, compressed air tank, or other source of air at a pressure above atmosphere. The pressure of air delivered from the source can be controlled or set using any known mechanism, e.g. using a regulator, orifice plate, or the like. The mechanism may form part of the source 132 or be a stand-alone component of the pressure compensation system. The source 132 is in fluid communication with the pulsation volume 110 of (the or) each milking cup 102 via a positive pressure fluid delivery line 134, which in this example joins the long pulsation tube via valve 133. As will be described in further detail below the pressure compensation system 130 is used to selectively apply positive air pressure to the pulsation volume 110 during the “off” phase of the pulsation cycle, so that a compressive load is applied to the teat during at least part of the off cycle. To aid this process the pressure compensation system 130 further includes a:
a sensing system 136 for measuring a fluid parameter (typically pressure, volume or flow) related to a pressure in the bore 108; and
a controller 138 configured to control the pressure compensation 130 system to adjust a level of positive pressure applied to the pulsation volume 110.

The controller 138 receives outputs from the sensing system 136 via a communications system 140. In the present diagrams the communication system 140 is illustrated to indicate logical connections between its elements. The system is preferably a wireless communications system, as this may reduce wires in an already cluttered environment and may also minimise installation costs. The communications system 140 may enable communication between the controller 138 and the one or more valves 133 or actuators of the pressure compensation system 130.

As will be appreciated from the following description, the pressure compensation system 130 may be a stand-alone system (e.g. that may be retro-fitted to an existing milking system) or its functions and components could be integrated, mutatis mutandis, into the pressure regulating system 122. Furthermore the source of positive air pressure can be connected to any convenient location from which positive pressure can be delivered to the pulsation volume, in the manner required. For example, it may be connected directly to any one of the following locations:

An inlet to a pulsator;

A pulsation volume;

At a position adjacent to or along the length of either a long pulsation tube or a short pulsation tube;

A volume or manifold in fluid communication with any one of the above.

Indirect connection to such locations through a pipe, hose, valve or other means is also possible.

The choice of where to connect the source or positive air pressure may involve a trade-off. Connection closer to the pulsation volume may be advantageous because it reduces the volume to be pressurised and improve system efficiency, but conversely it may be mechanically more difficult or less convenient, as it introduces more hardware nearer to the already complex cluster. On the other hand, connection nearer the pulsator may require pressurisation of a greater volume of the system, but may provide easier mechanical connection at a single location in the system.

As will be appreciated robotic milking systems generally do not have claws of the type described above, but have individual milking cups 102 which are independently connected to the milk line 112 and pulsation tube 112/113, as shown in FIG. 1c. As can be seen the teat cup 102 is similar to that of FIG. 1b and includes a shell 104 and a flexible liner 106 that includes a hollow bore 108. In use the milking cup 102 is positioned on the teat by a robotic arm, that is guided by a guidance system (e,g, a laser guidance system) and the bore 108 receives the animal's teat at its top end for milking. The milking cup 102 can be held to the robotic arm by a housing 109 in some embodiments. As can be seen, the lower end of the bore 108 is connected to an individual milk tube 116. As with the previous embodiment the liner 106 and shell 104 are sealed to each other in relative positions so as to create a pulsation volume 110 between them. Conventionally the robotic milking system will apply vacuum to the milk tube 116 and the pulsation tube 112 using a pressure regulating system analogous to that of the embodiment of FIG. 1. Each milking cup may have a dedicated pressure regulating system (conventionally a pulsator) or a pressure regulating system (conventionally a pulsator) can service all four milking cups.

As this type of milking cup 102 does not connect to a cluster it is necessary to determined pressure in the bore 108 of the milking cup 102 directly or the milk line 116. Accordingly when using a milking cup and automatic milking system of this type, the sensing system 136 may include individual sensors 136a in each milking cup 102 for measuring a fluid parameter related to a pressure in the bore 108 (typically pressure, volume or flow). The sensor 136a will then communicate with the controller via a wired or wireless communications system 140 in the manner described above.

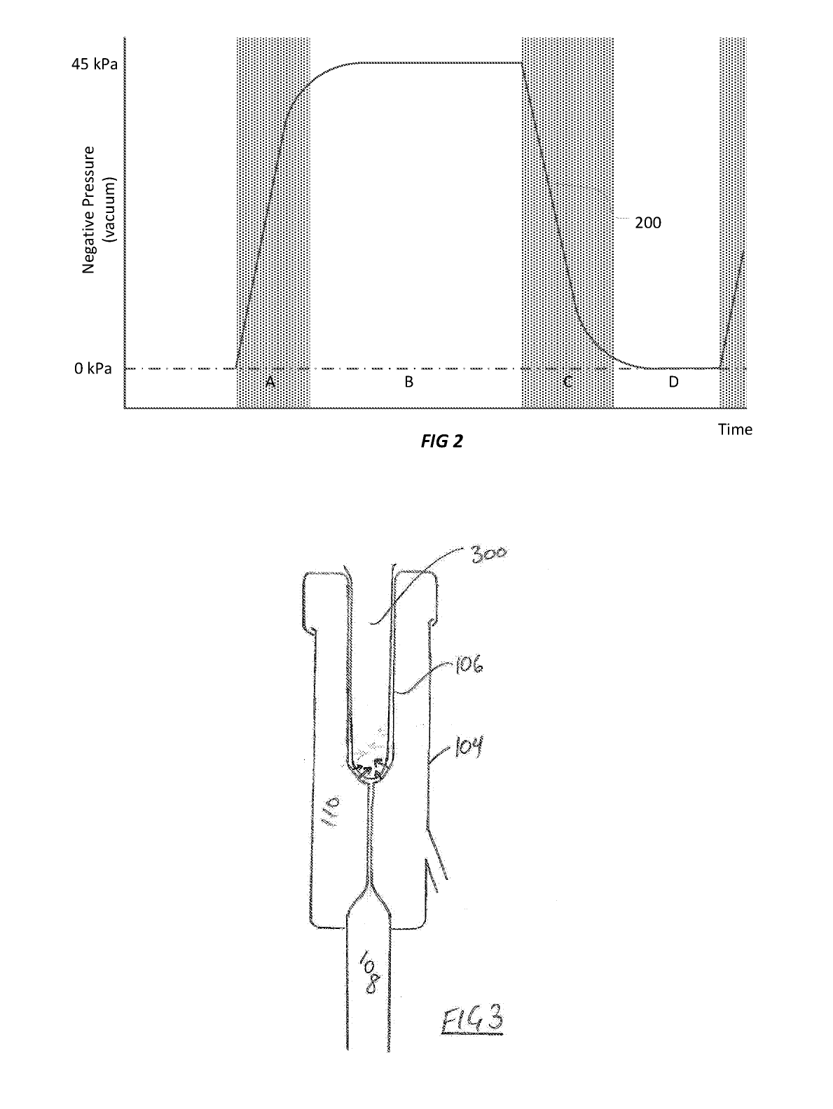

FIG. 2 illustrates a plot 200 of the vacuum level applied to the pulsation volume 110 during the pulsation cycle. The plot 200 takes a generally saw-toothed form. Transitions from the bottom of the cycle (point of lowest vacuum) to the top of the cycle is gradual, whereas, at the onset of vacuum release, a sharper drop occurs. As should be recognised by those skilled in the art, the cycle has four phases as follows:
“B” phase, or the “On” phase in which a relatively high vacuum level is applied to the pulsation volume 110. In this phase, the vacuum applied is sufficient for the liner 106 to be pulled open by the vacuum applied in the pulsation volume Conventionally the vacuum applied will be in the vicinity of 46 kPa (say 40 to 50 kPa). Moreover the vacuum applied is the same as that applied to the milk tube 116. In preferred embodiments of the present invention however, the vacuum applied is less than 42 kPa. The vacuum applied can be less than 40 kPa. Preferably it is less than 38 kPa. Most preferably it is less than 36 kPa. A preferred form uses about 35 kPa.
“D” phase, or “off” phase, in which the pressure in the pulsation volume 110 is higher (i.e. vacuum decreased) than in the B phase. In this phase the liner 106 collapses around the teat. Conventionally, in this phase the pulsation volume is at atmospheric pressure.
“A” phase is a transition between the end of the D phase and the beginning of the B phase. During this phase the pulsator 122 connects the pulsation volume 110 to the vacuum system 120 to draw air out of the pulsation volume 110.
“C” phase is a transition from the B phase to the D phase. In this phase the vacuum in the pulsation volume 110 is released (i.e. air is allowed into the pulsation volume). Conventionally this is achieved by the pressure regulation system 122 opening the pulsation volume to atmosphere.

Embodiments of the present invention modify this conventional process as follows:
During the C phase, instead of merely opening the pulsation volume to atmosphere, air under positive pressure is introduced into the pulsation volume 110. This causes the pressure in the D phase to be greater than atmospheric pressure. In turn this ensures that a positive compressive load is applied to the teat by the liner 106. FIG. 3 illustrates a milking cup 102 in which a teat 300 has been inserted. The milking cup is shown during the D phase, in which the pulsation volume 110 is positively pressurised. As illustrated the concept of compressive load applied to the teat is illustrated by the arrows near the teat's 300 end. The compressive load is applied by the liner 106 to the teat measured in a direction normal to the surface of the liner 106 at the point of contact.

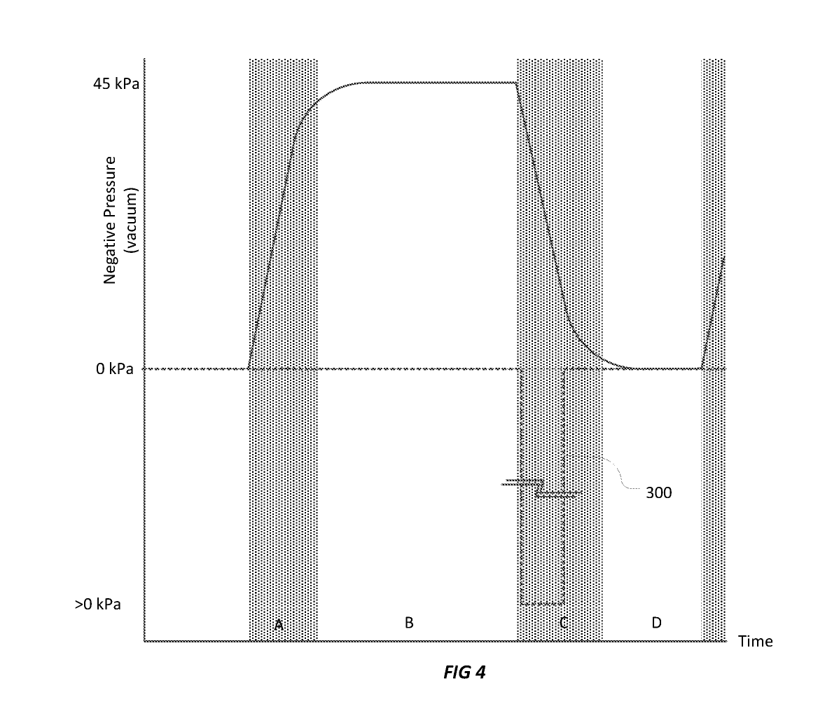

The pressure compensation applied to the pulsation volume is illustrated in FIG. 4. In this figure the pulsation pressure modulation plot 200 is illustrated along with a plot 400 of the positive pressure applied by the pressure compensation system 130. As can be seen, the pressure compensation system applies positive pressure at a point during the C phase which is maintained during the D phase.

In a preferred form, the positive pressure is applied by injecting a predetermined volume of air of known pressure air into the pulsation volume 110. The volume of air to be injected can be determined by knowing the volume of:
the pulsation volume 110 (including any reduction in volume caused by the use of an insert 700),
the short pulsation tube(s) 112,
the portion 113′ of the long pulsation tube(s) 113 between the valve 133 and the milking cluster; and
any connecting components or manifolds;

and then injecting an appropriate volume of air at the known pressure. This may advantageously be performed by allowing air at a known pressure to flow into the positive pressure fluid delivery line 134 for a determined period of time.

This has been found to be preferable to measuring pressure and injecting air until the desired pressure has been reached, as the volume based approach can be performed more quickly than the pressure based approach, although either may be used.

When the positive air pressure is injected into the long pulsation tubes 113, the pulsator 122 is isolated from the long pulsation tube by valve 133, so that the pulsator 122 does not release the positive pressure in pulsation volume 110. In a preferred embodiment the valve 133 is placed as close to the cluster as practical, however it may be placed at any point. Minimising the distance between the valve 133 and the cluster decreases the volume of the portion of the pulsation tube 133′ to be positively pressurised, which in turn minimises the time taken to perform pressurisation, and reduces pressure loss. In other embodiments, the positive pressure air could be introduced directly to the cluster or pulsation volume 110 of the milking cups 102 or into the short pulsation tubes 112, but these schemes require additional valving so may be less cost effective. FIG. 9 also shows an embodiment in which positive air pressure is introduced at the pulsator 122.

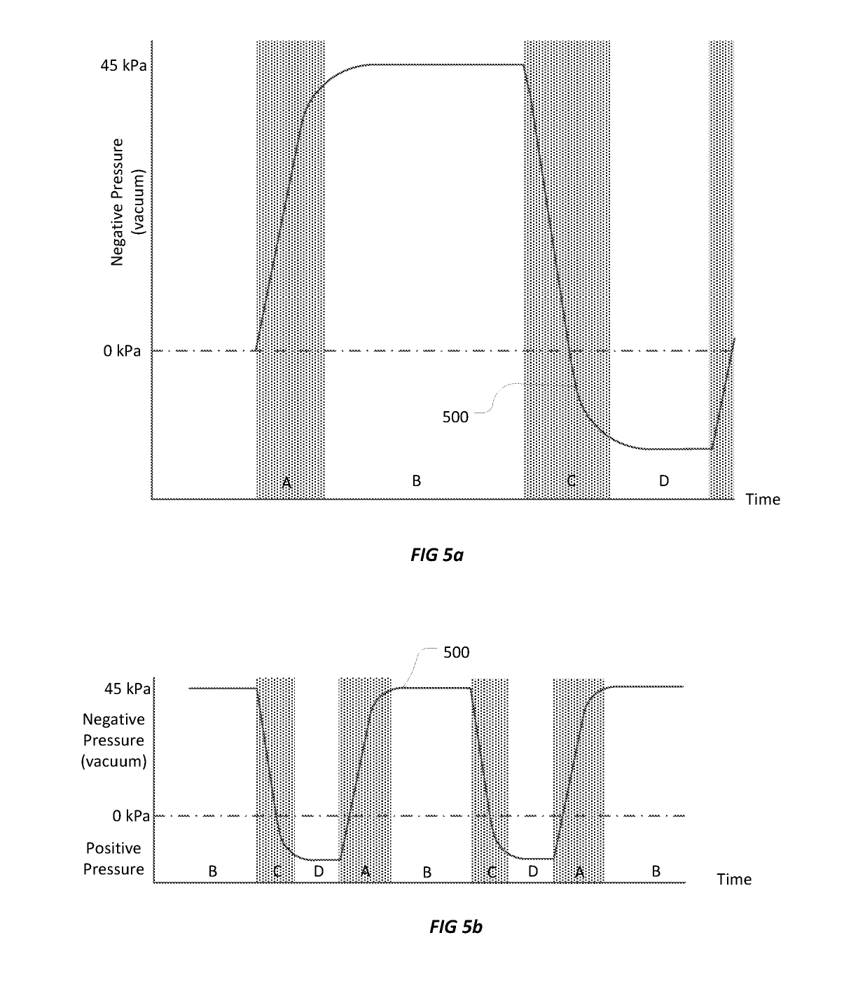

The resulting pressure modulation profile 500 within the pulsation volume 110 is illustrated in FIG. 5a. After the B phase, the pulsator 122 releases the vacuum in the pulsation volume 110 and the C phase is entered. Shortly thereafter (on the order of 10 ms) the air under positive pressure is applied to the pulsation volume 110 and the pressure in the pulsation volume 110 increases. However, instead of equalising at atmospheric pressure, (˜101.3 kPa), pressure is increased to above atmospheric pressure. FIG. 5b illustrates a similar plot to that of FIG. 5a but shows the operation over several pulsation cycles. As will be appreciated the C phase is conventionally initiated by the pulsator 122 opening the long pulsation tube volume to atmosphere to release the vacuum. The A phase is initiated by connecting it back to vacuum. However in order to avoid the pulsator 122 releasing the positive pressure that is added to the pulsation volume 110 during the C and D phases the pulsator 122 is isolated from the pulsation volume 110 by a valve (valve 133 in this example).

As noted above the introduction of positively pressurised air into the pulsation volume 110 is to apply compressive load to the teat to drive blood and lymphatic fluid upwards and out of the teat during the off phase of the pulsation cycle. To do this the compressive load applied is preferably be above blood pressure level, say about 0.8 to 1.2 N/cm², but may preferably be in a range of 2.0 N/cm² to 3.0 N/cm². It is believed that the an effective compressive load is at or about 2.5 N/cm², but in other embodiments additional compressive load may be advantageous, for example in the range of 2.5 N/cm² to 3.5 N/cm².

Accordingly a key aspect of the preferred embodiments is the control of the pressure compensation system 130 and in particular the determination of the level of positive pressure to be applied during the D phase, so as to achieve the desired compressive load on the teat. This is preferably performed by determining the pressure in the liner's bore 108, below the teat. The measurement, at least during the on (B) phase, of the pulsation cycle is important as it has been determined by the inventor that the flow of milk in the liner bore 108 causes a significant reduction in the vacuum level actually experienced at the teat, regardless of the constant vacuum applied by the vacuum source 120. Thus the pressure can be determined by direct measurement of pressure in the bore 108, if suitable sensors are available, or measurement of any value that is related to this pressure. For example pressure could be measured at or near the lower end of the liner bore 108. Alternatively it could be measured in the chamber of the claw 114 or even the milk tube 116. In other forms the pressure can be estimated by measuring milk flow rate or milk volume at the same or similar locations. To this end, a sensing system is provided that includes at least one transducer to measure a fluid parameter. In this example the transducer is an air pressure sensor 136 in the claw 114. Since this chamber may be in fluid communication with the liners of several teat cups, the single measurement will apply to all such cups. However, measurement may be performed on a cup-by-cup basis to enable individual control of compressive load on individual teats. The sensor 136 communicates the measured pressure data back to the controller 138 via a communications network 140. The communications network can be any type of suitable wired or wireless network. However a communications network using one or more wireless channels, (e.g. Bluetooth, Wi-Fi, ZigBee, IR, RFID, NFC, cellular technologies like 3G or 4G and the like) may be advantageously employed. In systems whose sensing systems include with multiple transducers per milking cluster, the communications components for a cluster can be shared amongst the transducers, or dedicated per-transducer communications components used.

The pressure sensor is arranged to transmit measured pressure data to the controller 138. The data can be sent according to any scheme, for example it may be pushed by the sensor 136 or sent in response to a request from the controller 138. Moreover measurement can be performed continuously, intermittently or periodically depending on requirements.

The controller processes the received value and determines therefrom the pressure drop in the insert bore 108 and the necessary positive pressure to apply to the pulsation volume 110 in order to cause closing of the liner bore and application of the desired compressive load to the teat. The correlation between the compressive load applied to the teat, and pressure drop in the liner bore 108, and the necessary positive pressure to be applied to the pulsation volume can be determined empirically or by calculation. The level of compensatory positive pressure to be applied to the pulsation volume 110 can be set dynamically so that the compressive load substantially matches a target compressive load level (e.g. 2.5 N/cm² to 3.5 N/cm².) or by a pressure level selected from a set predetermined pressure levels. For example the controller 138 can have access to a look up table that includes a series of compensatory pressure values (P1, P2, P3, P4) which will be used if the determined operating pressure drop in the liner bore 108 falls within predetermined bands (e.g. 2-7 kPa, 7-12 kPa, 12-17 kPa and greater than 17 kPa).

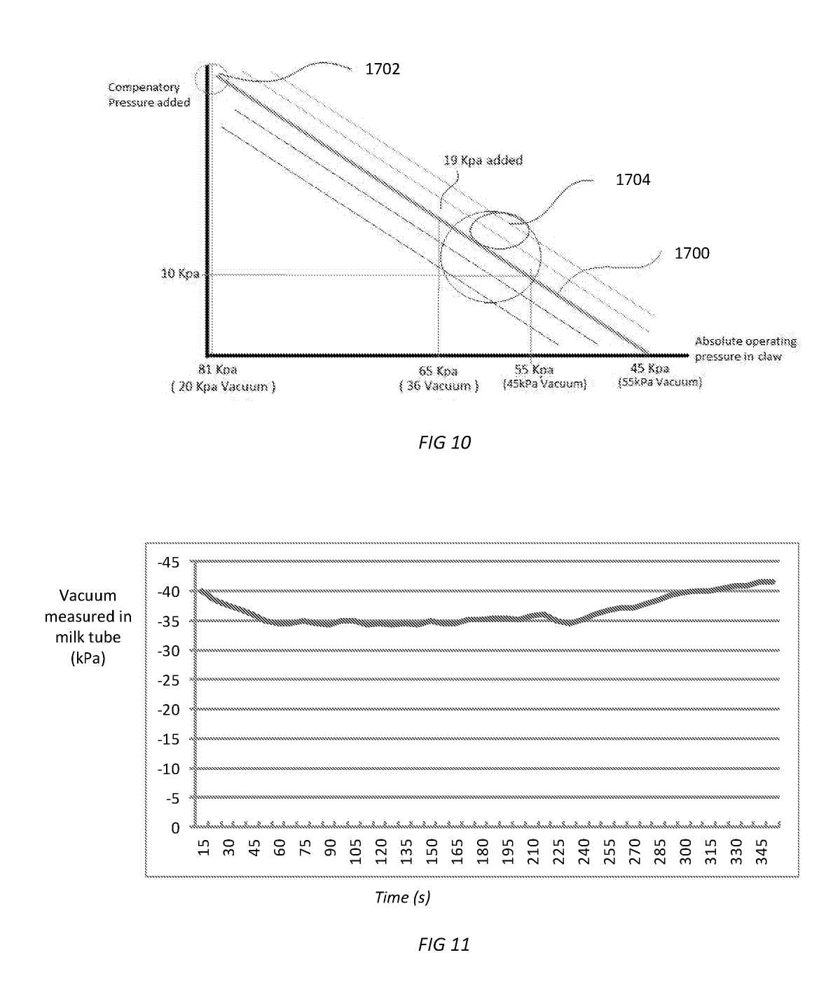

FIG. 10 illustrates a plot of a relationship between absolute pressure in the liner bore and the level of positive air pressure that may be added in an embodiment of the present invention. In the plot the horizontal axis shows the absolute pressure level determined in the liner bore of a milking cluster. In the present specification the term vacuum is used to indicate a relative low pressure compared to atmospheric pressure. Hence FIG. 10 also illustrates the “vacuum” level at each absolute pressure, assuming standard atmospheric pressure of 101 kPa.

The vertical axis illustrates the level of compensatory positive pressure that the system may apply. In use the farmer, technician commissioning setting up the system, or manufacturer can select a desired compressive load to be applied to the teat. Each of the diagonal lines indicates a compressive load level, which can be used to determine the level of positive air pressure that needs to be added, for a given measured operating pressure on the teat. The central compressive load level 1700 represents a base line that may be used, but a user of the system can select a desired compressive load represented by one of the other diagonal lines. The level or targeting of the dial in can be low, e.g. seek to achieve a compressive load within the larger circle indicated or within the tighter region 1704. The variation of positive pressure that may be needed can be seen by the relationship illustrated. For example, increasing vacuum to 55 kPa would remove the need to have any positive air pressure applied, but teat health would suffer. If a vacuum level of only 20 kPa is used a compensatory air pressure level of about 35 kPa would be needed if the baseline curve is selected.

As will be appreciated by those skilled in the art, different milking systems will have different physical configurations. These are typically classified as either high line or low line systems depending on the route followed by the milk after it leaves the cluster. In high line systems the milk tube runs to a point above the cluster so the milk needs to be drawn up the milk tube. The height to which the milk must be drawn varies from dairy to dairy, but will typically be over a metre and possibly as high as 1.8 metres. This affects the level of vacuum that needs to be applied to the milk tube to lift the milk to this height. Conventionally a high line system that raises the milk by between 1.2 and 1.4 metres will use 46 kPa of vacuum on the milk tube, whereas a system that raises the milk by between 1.4 and 1.8 metres may use 48 kPa of vacuum on the milk tube. These high system vacuums translate to correspondingly high operational vacuums applied to the teat during milking. So called low line systems and rotary systems do not need to lift milk above the cluster, hance gravity assists in drawing milk away from the cluster. As a result these systems typically use a lower system vacuum approaching 42 kPa.

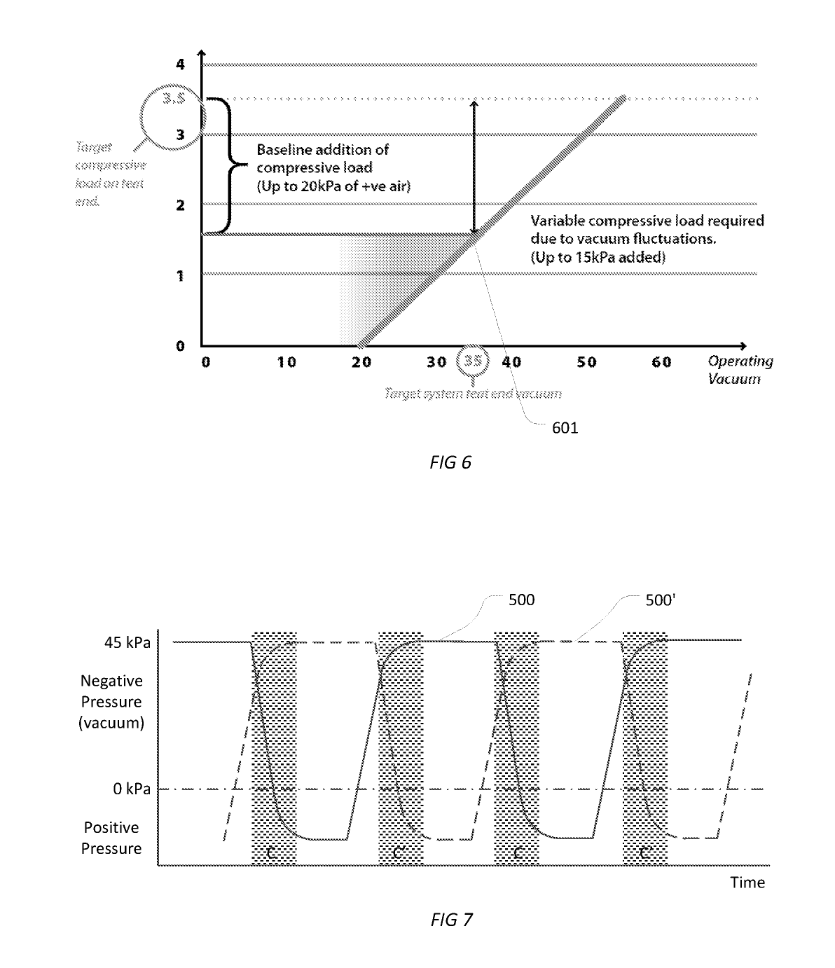

The following gives several examples of how the selection of compensatory pressure may be made in different systems. In each case the selection may be automatic (e.g. performed by the controller 138 according to an algorithm, or set manually). The initial assumption is that at 46 kPa Vacuum will achieve 25 kPa pressure on the teat, as indicated in FIG. 6.

Example 1—First the system vacuum is set. In this case at 42 kPa. To compensate for this first reduction in pressure, 4 kPa positive pressure added for each D Phase. Additionally further compensatory pressure is added to counteract the reduction in vacuum experienced as milk flows. In this example we assume a 9 kPa drop is measured by the sensing system. The assumption is based on the inventor's test results. An example set of test results are set out in FIG. 11. FIG. 9 shows a graph (over time) of the measured vacuum pressure in the bowl of the claw of a high line milking system operating with a 44 kPa system vacuum, which has a 1400 mm milk lift from the cluster. The claw had a bowl reserve volume of 300 m. In this data set pressure was measured using a pressure sensor mounted in the cluster every 7.5 seconds over the milking cycle of a cow. The operating vacuum drops to an acceptable level of 37 kPa after about 30 second, and remains there until about 4 minutes and 20 seconds, after which the vacuum level rises again. This represents a total pressure drop of between 2.4 and 9.8 kPa during milking.

Returning to the example, the sensing system could be of any type described herein. Therefore a total of 4 kPa+9 kPa positive air pressure is added during the D phase of the milking cycle. If however more compressive load on the teats is desired (e.g. to minimise cup slip or to enable a further reduction in system vacuum, so that the operating vacuum at the teat end at the start and end of the milking process is kept closer to 35 kPa for longer) is desired, additional positive pressure air can be added—effectively thereby selecting a compensatory pressure level above the “base line” level 1700 indicated on FIG. 10.

Example 2—The system vacuum (being from the source of vacuum 120) applied in this example is 44 kPa, and the farmer or technician (due the dairy configuration or other preference) desires an increased compressive load on the teat at all times, that is a pressure level above the baseline 1700 is desired. Furthermore, a vacuum reduction to 25 kPa in the cluster is measured (e.g. the system may be a high line system prone to slugging and high vacuum variation).

Thus, in this example 19 kPa positive pressure is need to compensate for the additional measured vacuum drop. Accordingly in this example 29 kPa positive pressure is applied in the D phase in the manner described above.

The controller 138 determines how to control the valve 133 to admit the appropriate amount of positive pressure air. In this example the positive pressure air is at 4 atmospheres, is admitted at a flow rate of 60 L/min, and the volume of the pulsation volume and pulsation line beyond the valve is 210 ml. The volume of positive pressure air to add can be calculated as follow:

$$Total Volume ( at 1 ATM ) = Volume of pulsation volume to be filled \times Total compesatory pressure ( Abs kPa ) \text{/} 101.3 kPa$$

In this case, this equates to 60 mL of air at 4 Atm to add. Using the known flow rate the valve open time can be determined to be 60 ms.

Example 3—This example seeks to operate at 40 kPa vacuum and achieve a 35 kPa (3.5 N/m²) compressive load on the teat at all times. Therefore, based on the correlation of operating vacuum and compressive load from FIG. 6, a first positive air pressure component of 15 kPa is added to achieve this. Next if the vacuum falls during milking to 33 kPa an additional 7 kPa positive pressure is needed to compensate for this.

Hence 22 kPa total compensatory pressure is needed to achieve the desired compressive load. This can be achieved by the controller to cause the valve to admit 45 mL of positive pressure air, in a manner analogous to example 2 (4 Atm and 60 L/min flow rate, same pulsation volume). This means that the open time for the valve is 45 ms.

As will be appreciated different compressive loads can thus be achieved by selecting the appropriate “pressure level” to apply and the volume of positive pressure air to be added can readily be computed by the controller 138. The controller will be suitably programmed to output control signals to the valve 133 to operate as desired.

As noted above the operating pressure in the lower part of the liner bore 108 will drop due to milk flow. However the pressure drop may not be uniform over time, for example hydraulic effects can cause variations in vacuum level on time scales ranging from fractions of a second to many seconds, thus the fluid parameter measured by the sensing system may also fluctuate. To compensate for this the (or each) measured parameter, a corresponding determined pressure value or compensation pressure value can be averaged, low-pass filtered or otherwise smoothed to take out such variations. For example, the sensor outputs or determined pressure can be a rolling average over a window of between 1 and 10 seconds.

FIG. 6 illustrates a plot of compressive load applied to the teat of an animal being milked at different levels of operating vacuum under the teat during the pulsation cycle. As can be seen, if the operating vacuum falls to below 20 kPa the liner may (or may not) close, but no compressive load will be applied to the teat. If 45 kPa operating vacuum is maintained, then a compressive load at about 2.5 N/cm² is achieved. However, as noted above, this level of operating vacuum applied to the teat end causes animal discomfort and ultimately can cause teat damage. However, it has been found that the milk flow in the liner reduces operating vacuum during the milking cycle so compressive load decreases and as a result cup slip can occur. Generally speaking the prior art approach to this problem would be to increase the system vacuum level to overcome the cup slip. In contrast to this, in preferred embodiments additional positive pressure air (at the right pressure level) is used to raise the compressive load applied to the teat, instead of increasing the system vacuum. In fact in some embodiments, by applying additional compressive load in this manner a reduction in system vacuum can be permitted, which in turn reduces the operating vacuum applied to the animal's teat.

According to preferred embodiments of the present invention, positive pressure can be applied to the pulsation volume during the C phase of the pulsation cycle to lift the compressive load on the teat back into the zone 606 on FIG. 6, regardless of the operating pressure drop that occurs.

Since the controller 138 knows the volume to be pressurised and the pressure of the air delivered from the source 132 it can calculate the volume of air to be delivered to achieve the determined positive pressure. In the preferred embodiment this is converted to a control signals for solenoid valve 133. The solenoid valve 133 is arranged to connect the positive fluid pressure line to long pulsation tube(s) 113 for a time determined by the pressure level to be applied. This results in the air pressure in the pulsation volume 110 being increased to the determined positive pressure level. When the positive air pressure is injected into the system the pulsator 122 is isolated, from the long pulsation tube 113 by valve 133 so that the pulsator 122 does not release pressure in the pulsation volume 110.

In a preferred form, the controller 138 sends two control signals to the solenoid valve 133. A first control signal will indicate when to open, and/or an opening sequence type. The sequence type will be determined by the timing of the pulsation sequence and type of cluster, e.g. whether the cluster is a 2×2 cluster or 4×0. The second control signal will be either a closing time or the length of time over which the valve should remain open (i.e. a duration of pressurisation). In order to synchronise the pressure compensation system's 130 controller 138 with the pulsation cycle an input can be received from a control system forming part of the pulsation system 122.

In a preferred form the cluster is a 2×2 cluster, and thus pulsation to the cups occurs in pairs with the pulsation sequences interleaved in time and offset from each other by half a period. When such a system is used the valve 133 can be a three way valve, which alternately connects the positive pressure air source 132 to a respective one of the pair of long pulsation tubes during the C phases or their respective pulsation cycles. As noted above valve 133 also isolates the pressurised portion of the long pulsation tube, short pulsation tube and pulsation volumes of the two milking cups connected thereto from the pulsator 122 until the D phase ends.

FIG. 7 illustrates a plot similar to that of FIG. 5b showing the modified pressure in pulsation volume in an embodiment of the present invention having 2×2 pulsation. As can be seen two pulsation cycles 500 and 500′ are illustrated. The pulsation cycles 500 and 500′ are interleaved with each other and out of phase by half a cycle.

It should be noted that in alternative forms different valving and connection arrangements for the pulsation system 100 and pressure compensation system 130 may be used.

FIG. 9 illustrates one such example. The example is similar to the previous embodiment and the same features have been numbered with the same reference numerals to aid understanding. In this example, the pressure compensation system is connected directly to the pulsator 122, so that positive pressure air is provided directly to the pulsator 122. In this example, the source of positive pressure 132 is connected to the pulsator 122 by the positive pressure fluid delivery line 134. An isolator valve 133′ is also provided on the positive pressure fluid delivery line 134.

In general the present example operates, as follows. Instead of the pulsator 122 exposing the pulsation volume 110 to atmospheric pressure in the C and D phases of the pulsation cycle (as in the previous embodiment), it is instead exposed to the source of positive pressure 132. The source of positive pressure 132 may be provided with a pressure regulating system, e.g. a regulating valve 133′ or the like, to enable control of the level of positive pressure applied to the pulsator 122. The pressure regulating system can be controlled in accordance with the methods described herein to achieve the desired compressive load on the teat, as the desired time within the pulsation cycle.

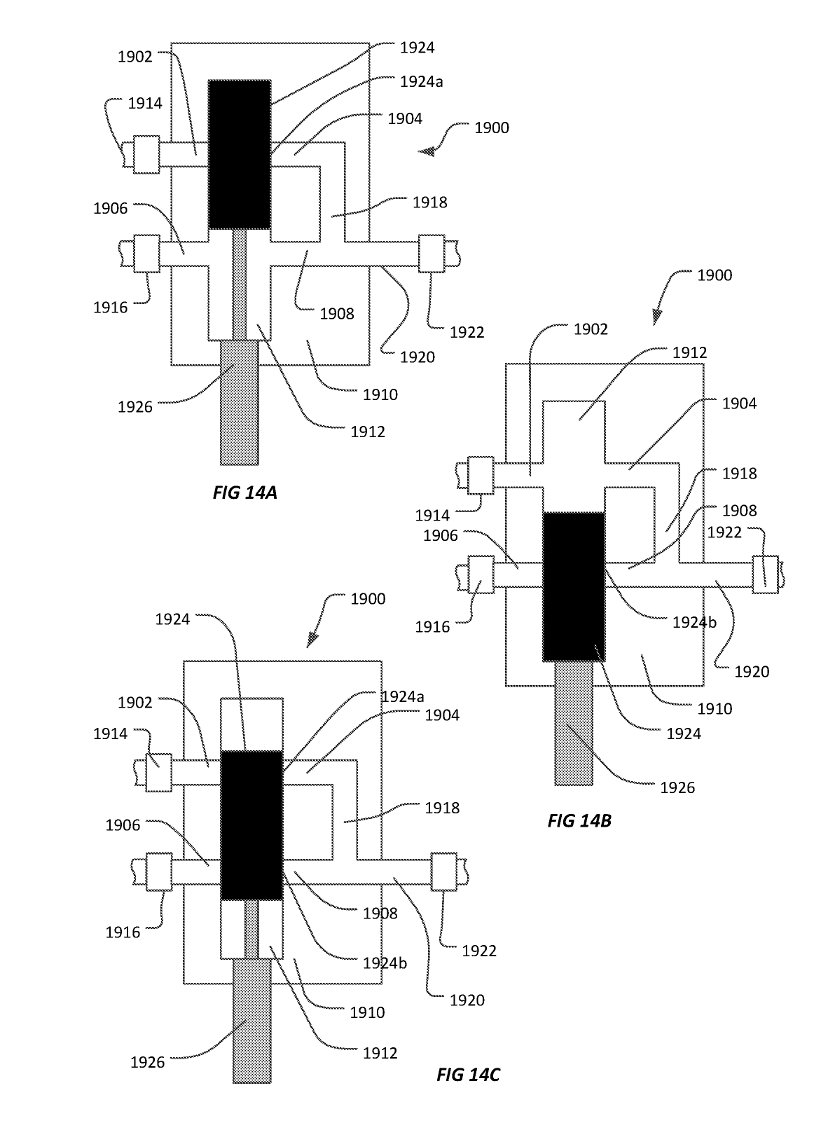

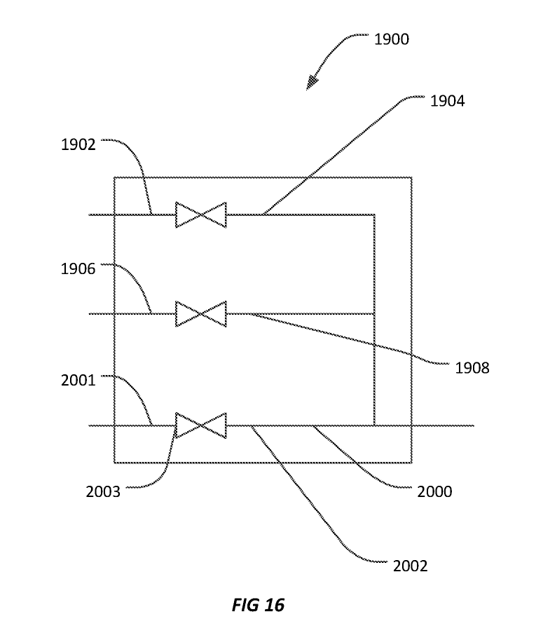

The regulating valve 133′ could be a stand-alone device, receiving a separate control signal, or integrated into either the pulsator 122 or source of positive pressure 132. A valve arrangement which combines these functions is described in connection with FIGS. 14a to 16 below.

Other than the route by which the source of positive pressure 132 is connected to the pulsation volume, the present embodiment works in the identical manner to the previous embodiments.

In preferred forms of each of the embodiments described above, the source 132 will preferably supply air at a pressure of between 1 and 4 bar. The opening durations will typically be between 10 and 130 ms long. Most preferably they are between 30 and 100 ms. This may vary depending on liner type.

It has also been realised by the present inventor that it is desirable to minimise the duration of the C phase of the pulsation cycle. This allows a longer D phase and possibly a longer B phase, which may be beneficial for milk production rates and animal health.

Because cup slip is controlled at low teat end vacuum (due to the application of positive pressure) and positive pressure air is used to cause liner closing for at least part of the C phase, the preferred embodiments enhance the ability to control the timing of the pulsation curve. For example the (A+B):(C+D) timing ratio can be controlled, as can the length of the B phase (for improved milking speed) at low vacuum.

The application of positive pressure to the pulsation volume 110 itself, may cause a decrease in C phase time, but to further decrease it, and further control the application of compressive load preferred embodiments use a milking cup with a minimised pulsation volume 110, and or a means to control the collapse of the liner bore 108.

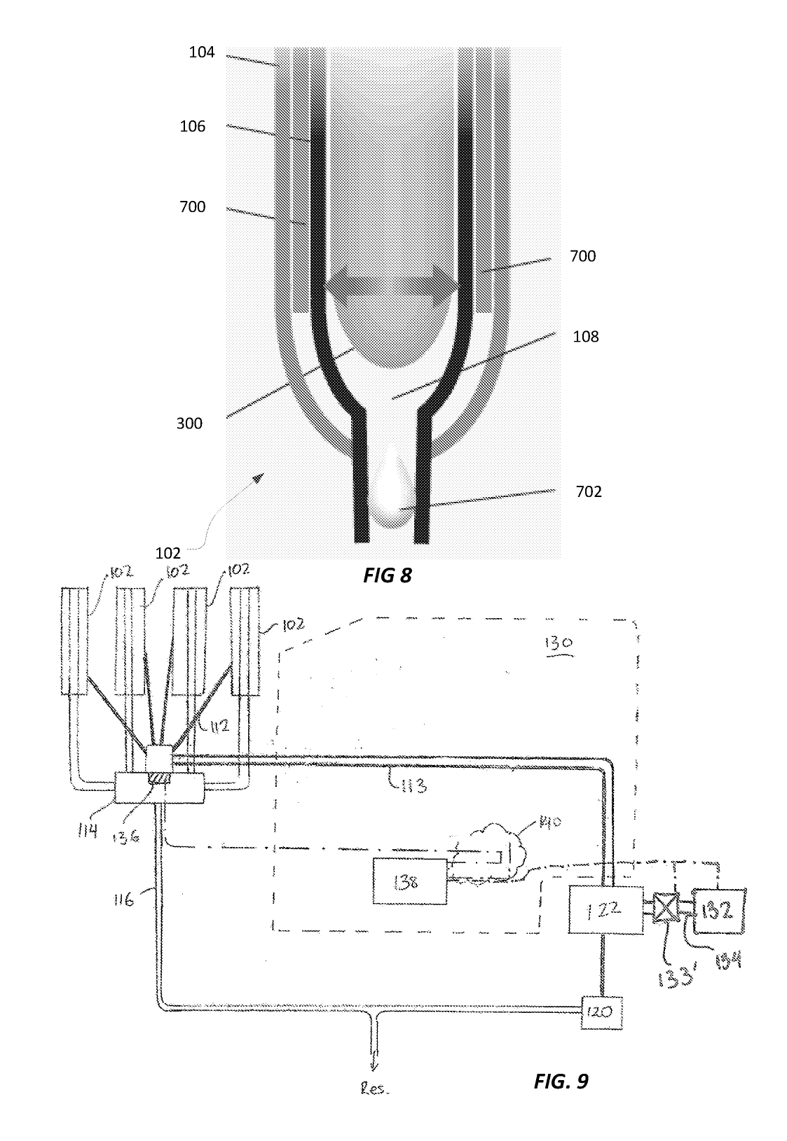

In a preferred form this is achieved by providing an insert within the pulsation volume 110. The insert can be of the type described in Australian patent application 2008202821, the contents of which are herein incorporated by reference, and as illustrated schematically in FIG. 8 of the present specification. Such inserts are sold under the brand name of “SurePulse”.

FIG. 8 illustrates a milking cup 102, that is the same as that shown in FIGS. 1a and 3, and the same features have been numbered with the same reference numerals. However the milking cup 102 has an insert 700 located in the pulsation volume 110. The insert 700 acts to minimise the air volume in the pulsation volume and acts as a collapsing means to cause sequential collapse of the liner against the teat from the lowermost part of the teat. Projections on the lower inner surface of the inert are provided that indent the liner to pinch the liner bore at a location below the tip of the teat. When positive air pressure is applied in the pulsation volume the liner 106 collapses from the position of the indentations so that compressive load is applied to the lowermost part of the teat before the application of compressive load higher up the teat.

The use of the insert can assist in ensuring that the compressive load is initially applied to the lowermost 1 to 3 mm of the teat, and most preferably at the lowermost 2 mm.

By minimising the pulsation volume 110, the amount of air to be delivered to positively pressurise the pulsation volume is decreased. This enables faster application of the positive pressure and minimisation of the C phase. The reduced volume may also increase the accuracy of pressurisation of the pulsation volume as a lower volume of air needs to be applied.

Finally the insert 700 can have further beneficial effects on teat health by limiting outwards movement of the liner 106, and controlling its collapse from the B phase to the D Phase. In some situations, the liner 108, if left unconstrained by an insert 700, can balloon during the B phase. Consequently when the vacuum is released in the C phase an uncontrolled elastic contraction of the liner 108 onto the teat can occur, which causes damage to the teat. Use of an insert 700 ameliorates this problem. In other embodiments a profiled shell can be used in place of the inserts. When using such shells the inside of the shells is profiled to be dimensionally similar to the inside of the inserts described above. In this case the collapsing means can include a projection formed on a profiled inner surface of the shell which operates like the projection on the insert.

As can be seen from the foregoing, the preferred embodiments of the present invention can enable one or more of the following advantages to be achieved:
An extension of the D phase of the pulsation cycle with sufficient compressive load. This can promote teat health by reducing congestion at the teat tip.
The increased compressive load on the teat during the D phase improves the gripping effect of the milking cup on the teat, which may lead to a decrease in cup slip.

By extension, the ability to achieve these benefits means that the vacuum level applied to the bore of the insert (i.e. milk tube) may be reduced without negatively impacting the milking process. In such case, a decrease in vacuum may additionally aid in promoting good teat health. In a particularly preferred embodiment of the present invention the method of milking comprises applying a vacuum of less than 40 kPa to the lower end of the liner—i.e. to the milk tube. Most preferably the vacuum is at 35 kPa or 36 kPa. During the “on” phase this has found to be sufficient vacuum to prevent the milking cups from dropping off the teat, whilst still achieving effective milking. Moreover, the ability to lengthen the D phase, and the added compressive load caused by the application of positive pressure air during at least the D phase can minimise cup slip without increasing vacuum toward or even above 46 kPa.

The vacuum applied to the pulsation volume during the B phase can also be reduced in line with the reduction in vacuum in the milk tube, as the additional vacuum is not needed to open the liner.

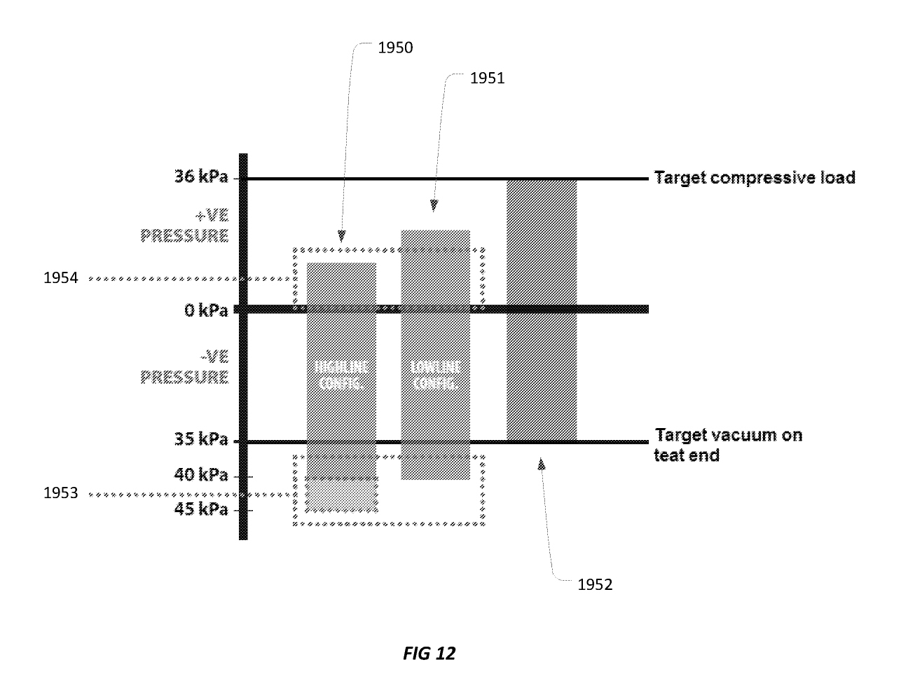

The present inventor has determined that the modification in the milking process set out above, can more closely mirror the forces (e.g. compressive load and sucking vacuum) applied by a suckling infant. It is believed that operating at or about the natural force range may be more sustainable from a teat-damage perspective. FIG. 12 illustrates this concept diagrammatically. The diagram shows, for three milking system configurations, the operating pressure experienced by the cow's teat end during milking and the compressive load applied to the teat. The three milking system configurations are as follows:
A high line milking system configuration (1950) which applies an operating vacuum of up to 45 kPa during the milking cycle.
A low line milking system configuration (1951) which applies an operating vacuum of up to 40 kPa during the milking cycle.
A milking system configured in accordance with the present invention (1952) which has had its system vacuum reduced so as to apply an operating vacuum of no more than 35 kPa during the milking cycle.

The dotted box marked with reference numeral 1953, indicates vacuum levels of above −37 kPa, over which the cows teats are damaged. Conventional milking systems typically operate in this pressure regime to avoid cup slip.

The dotted box marked with reference numeral 1954, indicates compressive load levels on the cow's teat of below 20 kPa. These can result in incomplete liner closure, and ballooning of the liner which cause congestion and teat damage. Conventional milking systems typically operate in this load regime because they have a fixed pressure differential between the pulsation volume and the liner bore controlled by selectively switching the presence and absence or vacuum between the two.

In contrast, embodiments of the present invention, decouple the control of the pulsation and cup gripping from the application of vacuum to the liner bore, by using the introduction of positive pressure air to move the liner bore. This can increase the compressive load on the teat by controlling the application of positive pressure to the pulsation volume 110 of the milking cup. This increases grip on the teat and prevents cup slip, and may also ensure correct and complete closure of the liner bore on the teat. The increased gripping effect of the milking cup, obviates the need to run high system vacuums which reduces the risks associated with box 1953.

Moreover by employing real-time pressure measurement techniques some embodiments of the present invention can adjust the compressive load during the milking cycle to maintain more desirable operational parameters, as can be seen in the following examples:

Example A: In a first example, a high line system is run with a system vacuum at 38 kpa. The target compressive load on the teat is 3.6 N/m², with a maximum teat end vacuum of around 35 kPa.

The system pressure losses results in an operating vacuum at the teat of 35 kPa (as measured by the sensor system) with low or no milk flow. Using the plot of FIG. 6 it can be determined that at 35 kPa vacuum indicated by arrow 601 the compressive load on the teat will be around 17 N/m² and hence at least 19 kPa of positive pressure needs to be added to the pulsation volume to raise the compressive load into the box 606 and up to the target compressive load of 3.6 N/m².

Once milk flows, the sensor system measures that the teat-end operating vacuum drops to 33 kPa, and an additional 2 kPa (to a total of 21 kPa) of positive pressure is added to the pulsation volume during the C and D phases of the pulsation cycle. Later during milking, the vacuum at the teat end falls to 30 kPa and an additional 6 kPa positive pressure (to a total of 25 kPa positive pressure) is added to the pulsation volume.

Example B: In a second example, a low line system is run with a system vacuum at 36 kpa. The target compressive load on the teat is 3.6 N/m², with a maximum teat end vacuum of around 35 kPa.

The system pressure losses results in an operating vacuum at the teat of 35 kPa (as measured by the sensor system) with low or no milk flow. Again using the plot of FIG. 6 it can be determined that at 35 kPa vacuum indicated by arrow 601 the compressive load on the teat will be around 17 N/m² and hence at least 19 kPa of positive pressure needs to be added to the pulsation volume to raise the compressive load into the box 606 and up to the target compressive load of 3.6 N/m².

Once milk flows, the sensor system measures that the teat-end operating vacuum drops to 30 kPa and an additional 6 kPa positive pressure (to a total of 25 kPa positive pressure) is added to the pulsation volume.

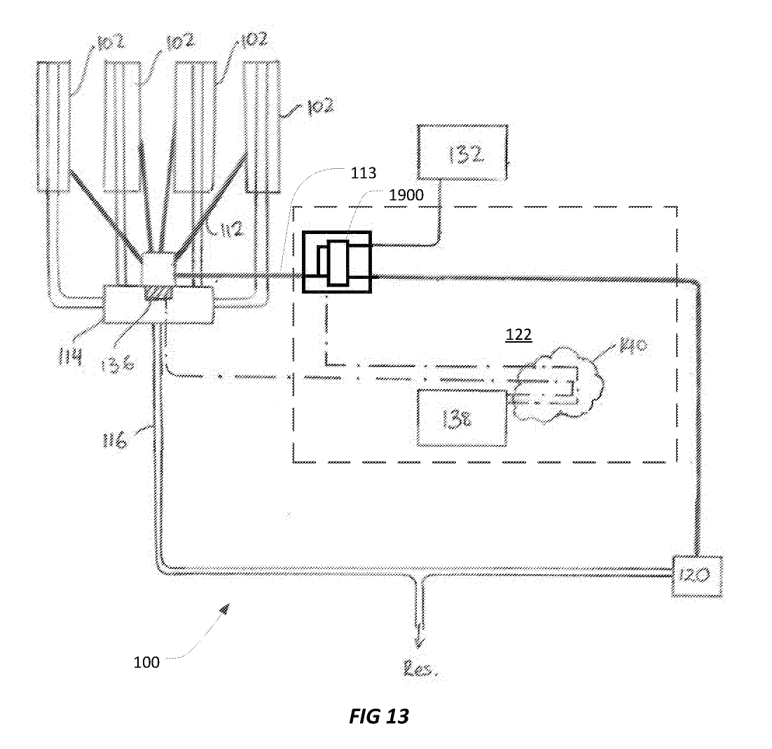

As noted above the pressure compensation system 130 may be integrated into the pressure regulating system 122. FIG. 13 illustrates a milking system including a pressure regulating system 122 modified in such a way. In the following description, as with previous figures, like numbered components perform like tasks and will not be explained in detail again for the sake of clarity.

In this embodiment the conventional pulsator is effectively eliminated from the milking system and instead replaced by a valve arrangement according to an aspect of the present invention, that controls the application of air at positive pressure (compared to ambient pressure) and air at negative pressure (i.e. vacuum) to the pulsation tubes of the milking cluster.

In this embodiment the milking system 100 includes a pressure regulating system 122 that has a three position valve arrangement 1900 coupled to:
the long pulsation tube 113 leading to the pulsation volume 110 of one or more teat cups by one (or more) long pulsation tube(s) 113 and respective short pulsation tubes 112;
an airline leading to the source of positive pressure air 132;
an airline leading to the vacuum system 120.

As with previous embodiments the controller 138 is configured to control the operation of the pressure compensation system to adjust the timing of operation of the valve 1900 to selectively deliver air of either positive air pressure, or vacuum to the pulsation via the claw 114. A wired or wireless communications system 140 is employed for communicating data between the sensor system 136 and the controller 138, and the controller 138 and the valve arrangement 1900.

Details of the valve arrangement 1900 are set out in FIGS. 14A to 14C. The valve arrangement 1900 generally includes two valves:
A positive air pressure valve that control the movement of air with positive air pressure between a positive air pressure inlet port a 1902 and a positive air pressure outlet port 1904, and
A vacuum valve that controls the coupling of vacuum between a first vacuum port 1906 and a second vacuum port 1908.

In use the positive air pressure valve, and vacuum valve operate in concert with each other. In this example this is achieved mechanically, as will be described below. By operating the valves together air pressure valve arrangement can take the following states:
(A) A first vacuum position (shown in FIG. 14A) in which the vacuum flowpath between the first vacuum port 1906 and the second vacuum port 1908 is open.
(B) A first pressurised position (shown in FIG. 14B) in which the first flowpath is open so that air at positive pressure applied to the positive air pressure inlet port 1902 can flow to the positive air pressure outlet port 1904.
(C) A blocked position (shown in FIG. 14C) in which both the vacuum flowpath and first flowpath are closed.

As can be seen, the valve arrangement 1900 includes a valve body 1910. The valve body include a body manifold 1912 into which the first and second vacuum ports 1906 and 1908, and the positive pressure air inlet and positive pressure air outlet lead.

The valve arrangement also includes a first coupling 1914 to receive an airline delivering air at a positive air pressure for delivery to the inlet port 1902. In use, the airline will run to the source of positive pressure air 132. A second coupling 1916 to receive an airline for connecting to the vacuum source 120 for delivering air at a pressure below atmospheric pressure to the vacuum port 1906.

The valve arrangement 1900 further includes a coupling manifold 1918 located between the positive air pressure outlet port 1904 and the second vacuum port 1908. The coupling manifold couples these ports to the final outlet port 1920. The dinal outlet port Typically a third coupling 1922 will be provided to connect to an airline. This airline will typically be a long pulsation tube 113 which is ultimately in fluid communication with a pulsation volume 110 of at least one teat cup of the milking system 100.

As will be recognised, the coupling manifold can be omitted and individual couplings can be provided on the outlet port 1904 and the second vacuum ports 1908 respectively, An external junction can then be provided to couple each airline to the pulsation tube to enable fluid communication with a (the same) pulsation volume of at least one teat cup of the milking system.

The couplings can be of any type suitable for connection to airlines as might be used in a milking system, e.g. a quick release coupling, such as a carstick cartridge, a threaded pipe suitable to receive a compression fitting, a pipe configured to receive an airline and affixed with a separate fastener such as a pipe clamp or the like, a flange, or other suitable coupling.

The valve arrangement also includes a closure member 1924a and 1924b for each valve. The closure members 1924a and 1924b are moveable to open or close each valve. In this example embodiment, the closure members 1924a and 1924b are constituted by respective portions of a single closure member 1924. Thus the closure members 1924a and 1924b are mechanically coupled to each other so that they move in concert with each other. However in some embodiments they can be individual members. Use of a common or mechanically coupled closure members 1924a and 1924b facilitate correct actuation of the valve arrangement 1900. In a preferred form it enables use of a single actuator 1926 to actuate the valves together. Advantageously this may decrease complexity in manufacture (due to elimination of actuators) and ensures accurate relative timing in actuation of the valves.

The closure member 1924 will depend on the type of valve used. For example in a linearly actuated valve the closure member 1924 will be a spool or poppet, or other linearly movable closure member. The valves are actuated by rotational movement that closure member 1924 can be a plug or ball, or other rotatably moveable closure member. As will be appreciated either the walls of the valve body manifold 1910 or closure member 1924 (or both) will be furnished with suitable seals to prevent leaks and ensure correct operation of the valve arrangement 1900. However, these are not shown here for clarity.

The actuator 1926 can be an electronic actuator (e.g. a solenoid) or a pneumatic actuator operated by application of compressed air, or any other known type of actuator capable of causing movement of the closure member 1924 with sufficient speed.

In other embodiments (not shown) the closure members of the positive pressure valve and vacuum valves can be independently actuated, by respective actuators.

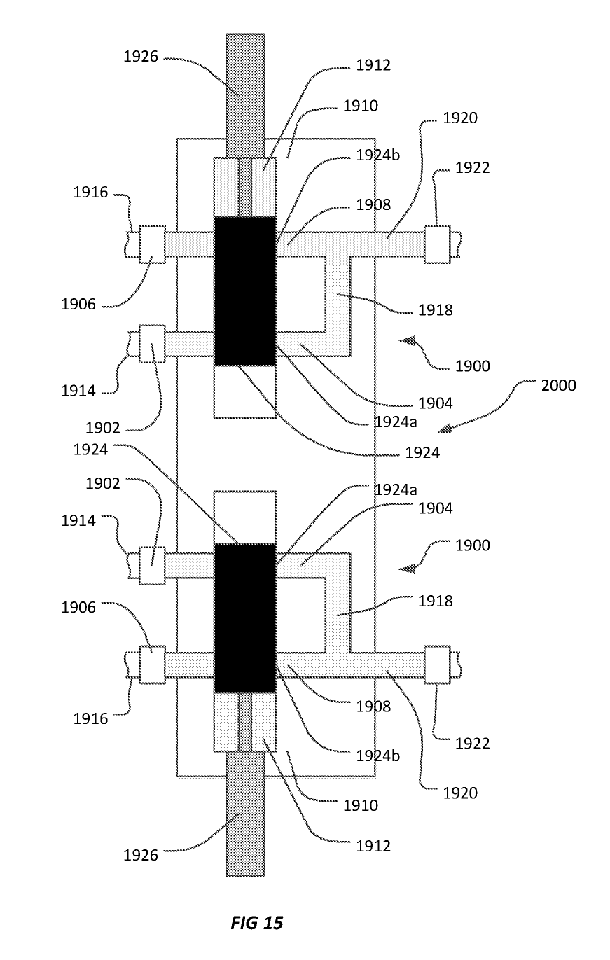

FIG. 15 illustrates a second embodiment of a valve arrangement according to the present disclosure. In this example the valve arrangement 2000 includes to valve arrangements 1900 as described in connection with FIG. 14. The individual valves 1900 are as described in the previous embodiment but share a common valve body in which two separate body manifolds are formed. Such a valve arrangement 2000 may find particular application in embodiments with multiple pulsation tubes, which need to be activated in the manner described in connection with FIG. 7. As will be appreciated, in such an embodiment a vacuum manifold can be provided between the two first vacuum inlets 1906 and provided with a single vacuum coupling. Similarly a positive pressure air manifold can be provided between the positive air pressure inlets 1902 and provided with a single coupling to the source of positive pressure air.

In use the valve arrangement 1900 of FIG. 14 can be operated as follows to implement a milking method as described in the related applications. In the present example the valve arrangement is used to provide a pulsation cycle as illustrated in FIG. 5b. Beginning at the commencement of the A phase, the valve 1900 is in the first vacuum position shown in FIG. 14A. In this state vacuum is applied to the pulsation volume 110 of the connected teat cups and the vaccum rises as indicated. The first vacuum position shown in FIG. 14A is held until the commencement of the C phase at about 600 ms, at which time the valve arrangement 1900 moves into the first pressurised position shown in FIG. 14B. In this state the vacuum is closed off and air under positive pressure is injected into the pulsation volume, causing the increase in pressure in the C phase of FIG. 5B. At the end of the C phase the valve arrangement 1900 moves into the blocked position as shown in FIG. 14C in which both valves are closed. The positive pressure is thus held in the pulsation volume 110, effectively holding the flat bottom on the pulsation curve in the D phase. This positive pressure in the pulsation volume 110 (and hence compressive load on the animal's teat, is held until the end of the D phase, at which time the valve arrangement moves back into the first vacuum position and the cycle repeats.

FIG. 21 is a highly schematic illustration of a further example of a valve arrangement 1900. For simplicity the actuation components and coupling components have not been shown. The valve arrangement 1900 is similar to that of FIG. 14a to 14c, except that it additionally includes a vent flowpath 2000. The vent flowpath 2000 runs between an atmospheric vent port 2001 and a connected vent port 2002. The connected vent port 2002 is arranged to be fluidly connected to the pulsation volume 110 and the atmospheric vent port 2001 is arranged to be in fluid communication with air at ambient air pressure. The vent flowpath also has a vent valve 2003 to control flow through the flowpath 2000. The valves of the valve arrangement are arranged to operate in concert as in the previous embodiments, however, the vent valve 2003 is arranged to open a path to atmosphere during a transition between the first vacuum position and the first pressurised position. This enables the air pressure in the pulsation volume 110 and pulsation tubes to equalise to atmosphere before the application of positive pressure air. The purpose of this is to reduce the volume of air that is needed to be applied under pressure, which can improve pressurisation accuracy in some instances. For example if one assumes a 10% error in the volume of air added by applying positive pressure air to the pulsation volume, caused for example by errors/inconsistencies in the speed of closing of the valve arrangement, then: in the case that a pressure of 20 kPa over atmospheric pressure is needed to be applied to the pulsation volume 110 and the system vacuum is −35 kPa, if the positive air pressure valve is timed to add air to achieve a 55 kPa pressure difference, this results in a possible pressure uncertainty of 5.5 kPa. However, if the positive air pressure valve is timed only to add the 20 kPa beyond atmospheric pressure (because the pressure is caused to reach atmospheric pressure using the vent valve 2003) the possible pressure uncertainty becomes only 2 kPa.

It will be understood that the invention disclosed and defined in this specification extends to all alternative combinations of two or more of the individual features mentioned or evident from the text or drawings. All of these different combinations constitute various alternative aspects of the invention.

1. A method of milking a mammal using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
Applying a vacuum to the lower end of the liner of less than 42 kPa;
Modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat.

2. A method of milking a mammal using a milking cluster including a plurality of milking cups of the type including a shell and a flexible liner, said liner including a hollow bore for receiving an animal's teat at a top end thereof, and being connected to a milk tube at the lower end thereof, said milk tube being adapted to apply a vacuum to the bore of the liner and convey milk to a milk reservoir; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; the method including:
for each milking cup, applying a vacuum to its liner bore;
modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat and to apply compressive load to the teat; the method further including:
determining a pressure in the bore; and
applying a positive pressure to the pulsation volume in the off phase, wherein the level of positive pressure applied is determined on the basis of said determined pressure.

3. The method of claim 2 wherein the vacuum applied to the lower end of the liner is between 34 kPa and 38 kPa.

4. The method of claim 2 wherein the vacuum applied to the lower end of the liner is about 35 kPa.

5. The method of claim 2 further comprising applying compressive load to the teat in a manner that causes application of said load at the lowermost part of the teat before the application of compressive load higher up the teat.

6. The method of claim 5 wherein compressive load is initially applied to the lowermost 1 to 3 mm of the teat.

7. The method of claim 2 which includes providing collapsing means to cause sequential collapse of the liner against the teat from the lowermost part of the teat.

8. The method of claim 7 wherein collapsing means includes either or both of:
an insert placed within the pulsation volume; and
a profiled inner surface of the shell.

9. The method of claim 2, further comprising connecting the pulsation volume to a source of air to apply the positive pressure.

10. The method of claim 9, wherein the method includes applying, from the source of air, a predefined volume of air to the pulsation volume that corresponds to the determined level of positive pressure to be applied.

11. The method of claim 2, wherein compressive load applied to the teat by the liner that is caused by the application of increased pressure in the pulsation volume is above 2.0 N/cm².

12. The method of claim 2, wherein the pressure in the bore is determined by any one or more of the following:
Measuring pressure at or near the lower end of the bore or other related position;
Estimating pressure at or near the lower end of the bore my measuring a milk flow rate or milk flow volume, from the bore.

13. The method of claim 2, wherein the pressure is determined at least at a time when milk is flowing during the “on” phase.

14. The method of claim 2, wherein pressure is determined at a plurality of points during the pulsation cycle across both the off and on phases.

15. A pressure compensation system for use with a milking system which includes:
at least one milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,
a vacuum system in fluid communication the bore of the liner and the pulsation volume;
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an
“off” phase in which the pulsation volume is at an increased pressure relative to the “on” phase to close the liner bore to thereby stop milk flow from the teat and to apply compressive load to the teat;
a milk reservoir in fluid communication with the liner bore and adapted to receive milk; the pressure compensation system including:
a sensing system configured to measure a fluid parameter related to a pressure in the bore;
a source of positive air pressure air in fluid communication with the pulsation volume; and
a controller configured to control the pressure compensation system to adjust a level of positive pressure applied to the pulsation volume based on said determined fluid parameter measurement.

16. The pressure compensation system of claim 15 wherein the sensing system further includes any one or more of:
a transducer to measure pressure located at or near the lower end of the bore or other related position;
a sensor to determine milk flow rate or milk flow volume, from the bore.

17. The pressure compensation system of claim 15, wherein the sensing system determines pressure at least at a time when milk is flowing during the “on” phase.

18. The pressure compensation system of claim 15, wherein the sensing system determines pressure at a plurality of points during the pulsation cycle across both the off and on phases.

19. The pressure compensation system of claim 15, which further includes collapsing means to cause sequential collapse of the (or each) liner against the teat from the lowermost part of the teat.

20. The pressure compensation system of claim 19 wherein the collapsing means includes either or both of:
an insert placed within the (or each) pulsation volume
a profiled inner surface of the (or each) shell.

21. The pressure compensation system of claim 15, which further includes a wireless communications system configured to enable communication between any one or more of:
The sensing system and controller;
The controller and one or more valves or actuators.

22. The pressure compensation system of claim 15, which is configured to cause a compressive load to be applied to the teat by the liner, that is preferably above 2.0 N/cm².

23. The pressure compensation system of claim 15, wherein pressure compensation system is configured to supply a predefined volume of air to the pulsation volume that corresponds to the determined level of positive pressure to be applied.

24. The pressure compensation system of claim 15, which includes one or more fluid delivery lines connected between a source of positive air pressure and the pulsation volume.

25. The pressure compensation system of claim 15, which further includes one or more valves or actuators to control fluid flow in the pressure regulating system.

26. A milking system including:
at least one milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,
a vacuum system in fluid communication the bore of the liner and the pulsation volume;
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to cause the liner bore to close to thereby stop milk flow from the teat and apply a compressive load to the teat;
at least one milk receiving sub-system, in fluid communication with the liner bore and adapted to receive milk; and
a pressure compensation system that includes:
at least one milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,
a vacuum system in fluid communication the bore of the liner and the pulsation volume;
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an
“off” phase in which the pulsation volume is at an increased pressure relative to the “on” phase to close the liner bore to thereby stop milk flow from the teat and to apply compressive load to the teat;
a milk reservoir in fluid communication with the liner bore and adapted to receive milk;
the pressure compensation system including:
a sensing system configured to measure a fluid parameter related to a pressure in the bore;
a source of positive air pressure air in fluid communication with the pulsation volume; and
a controller configured to control the pressure compensation system to adjust a level of positive pressure applied to the pulsation volume based on said determined fluid parameter measurement.

27. An air pressure valve arrangement for a milking system, said valve having:
a positive air pressure inlet port for coupling to a source of air at a first pressure above atmospheric pressure;
a first vacuum port for coupling to a vacuum source being a source of air at a pressure lower than atmospheric pressure;
a positive air pressure outlet port for outputting air at a second positive pressure above atmospheric pressure;
a first flowpath between the positive air pressure inlet port and the positive air pressure outlet port;
a vacuum flowpath extending from the first vacuum port to a second vacuum port
a positive air pressure valve movable between an open and closed position and located in the first flowpath to control the movement of air with positive air pressure between the positive air pressure inlet port and the positive air pressure outlet port;
a vacuum valve movable between an open and closed position and located in the vacuum flowpath to control the coupling of vacuum between the first vacuum port and the second vacuum port;
wherein the positive air pressure valve and vacuum valve are acuatable in concert with each other so that the air pressure valve arrangement can take the following states:
a first vacuum position in which the vacuum flowpath is open;
a first pressurised position in which the first flowpath is open;
a blocked position in which both the vacuum flowpath and first flowpath are closed.

28. A valve system for a milking system comprising a plurality of air pressure valve arrangements, wherein an air pressure valve arrangement for the milking system includes said value having:
a positive air pressure inlet port for coupling to a source of air at a first pressure above atmospheric pressure;
a first vacuum port for coupling to a vacuum source being a source of air at a pressure lower than atmospheric pressure;
a positive air pressure outlet port for outputting air at a second positive pressure above atmospheric pressure;
a first flowpath between the positive air pressure inlet port and the positive air pressure outlet port;
a vacuum flowpath extending from the first vacuum port to a second vacuum port
a positive air pressure valve movable between an open and closed position and located in the first flowpath to control the movement of air with positive air pressure between the positive air pressure inlet port and the positive air pressure outlet port;
a vacuum valve movable between an open and closed position and located in the vacuum flowpath to control the coupling of vacuum between the first vacuum port and the second vacuum port;
wherein the positive air pressure valve and vacuum valve are acuatable in concert with each other so that the air pressure valve arrangement can take the following states:
a first vacuum position in which the vacuum flowpath is open;
a first pressurised position in which the first flowpath is open;
a blocked position in which both the vacuum flowpath and first flowpath are closed.

29. (canceled)

30. (canceled)

31. The air pressure valve arrangement of claim 27, wherein said valve arrangement is part of a pressure regulating system, and a pressure compensation system forms part of the pressure regulating system.
